(19) United States
(12) Patent Application Publication
(10) Pub. No.: US 2013/0270082 A1
(43) Pub. Date: Oct. 17, 2013

(54) OPERATING DEVICE

(71) Applicant: KABUSHIKI KAISHA TOKAI RIKA DENKI SEISAKUSHO, Aichi (JP)

(72) Inventor: Makoto HARAZAWA, Aichi (JP)

(73) Assignee: KABUSHIKI KAISHA TOKAI RIKA DENKI SEISAKUSHO, Aichi (JP)

(21) Appl. No.: 13/856,693

(22) Filed: Apr. 4, 2013

(30) Foreign Application Priority Data
Apr. 11, 2012 (JP) 2012-090047

(51) Int. Cl. H01H 3/02

(52) U.S. Cl. CPC H01H 3/02
USPC 200/329

(57) ABSTRACT

An operating device includes an operating portion that is in a neutral position in a non-operating state, a first force generating portion arranged in the operating portion to generate a first force, a moderating piece to receive the first force applied from the first force generating portion, a moderating portion including a moderating recessed part against which the moderating piece receiving the first force is pressed, a guide portion to guide a movement in a direction of the first force and in the opposite direction thereto when the operating portion is located in the neutral position, a second force generating portion to generate a second force to press the moderating portion against the moderating piece, and a restricting portion to restrict a movement of the moderating portion relative to the guide portion.

The present application is based on Japanese patent application No. 2012-090047 filed on Apr. 11, 2012, the entire contents of which are incorporated herein by reference.

### BACKGROUND OF THE INVENTION

1. Field of the Invention

An embodiment of the invention relates to an operating device.

2. Related Art

An in-vehicle remote control system, which is provided with electric motors for applying an operation load with respect to an operation of an operating knob and a position detection mechanism for detecting a position of the operating knob, is known as a conventional technique (see, e.g., JP-A-2010-111304).

In this in-vehicle remote control system, the electric motors are provided so as to respectively correspond to X- and Y-axis directions in which the operating knob is operated .

### SUMMARY OF THE INVENTION

However, the conventional in-vehicle remote control system requires the electric motors in the X- and Y-axis directions and the position detection mechanism in order to apply an operation load to the operating knob, which results in a high manufacturing cost.

Accordingly, it is an object of the invention to provide an operating device that can switch the operation load (or operation feeling) by using a simple structure.

(1) According to one embodiment of the invention, an operating device comprises:

an operating portion that is in a neutral position in a non-operating state;

a first force generating portion arranged in the operating portion to generate a first force;

a moderating piece to receive the first force applied from the first force generating portion;

a moderating portion comprising a moderating recessed part against which the moderating piece receiving the first force is pressed;

a guide portion to guide a movement in a direction of the first force and in the opposite direction thereto when the operating portion is located in the neutral position;

a second force generating portion to generate a second force to press the moderating portion against the moderating piece; and

a restricting portion to restrict a movement of the moderating portion relative to the guide portion.

In the above embodiment (1) of the invention, the following modifications and changes can be made.

(i) The operating portion comprises an opening at an end, and the first force generating portion and the moderating piece are arranged in the opening.

(ii) The moderating piece comprises a retaining portion for preventing the moderating piece from falling out of the opening.

(iii) The first force is greater than the second force.

(iv) The restricting portion is composed of first and second restricting portions, and the moderating portion comprises a first support provided on a first side surface to support the first restricting portion and a second support provided on a second side surface opposite to the first side surface to support the second restricting portion.

(v) The second force generating portion substantially provides the operating portion with a first operation load before the restricting portion restricts the movement of the moderating portion relative to the guide portion, and

wherein the first force generating portion provides the operating portion with a second operation load when the restricting portion restricts the movement of the moderating portion relative to the guide portion.

(vi) The second operation load is greater than the first operation load.

(vii) The first force generating portion and the second force generating portion each comprises a resilient member.

(viii) The restricting portion comprises an actuator comprising a solenoid and configured to restrict the movement of the moderating portion relative to the guide portion.

(ix) The restricting portion comprises an actuator comprising an engaging part and configured to restrict the movement of the moderating portion relative to the guide portion.

### Points of the Invention

According to one embodiment of the invention, an operating device is constructed such that the operating portion receives two different operation loads from the first spring and the second spring, and the restricting portion allows the switching of the two different operation loads by restricting or not restricting the movement of the moderating portion (or detent portion) to be driven by the operating portion that is operated by user against one of the two different operation loads. Therefore, the operating device can switch the operation load by a simple structure.

### BRIEF DESCRIPTION OF THE DRAWINGS

Next, the present invention will be explained in more detail in conjunction with appended drawings, wherein:

FIG. 1 is a schematic view showing an operating device in an embodiment;

FIG. 2 is a diagram illustrating a schematic cross section of a major portion of the operating device in the embodiment; and

FIG. 3A is a diagram illustrating a schematic cross section of the major portion in the embodiment when movement of a moderating portion is not restricted and FIG. 3B is a diagram illustrating a schematic cross section of the major portion when the movement of the moderating portion is restricted.

### DESCRIPTION OF THE PREFERRED EMBODIMENTS

### Summary of the Embodiment

An operating device of the embodiment is provided with an operating portion that is in a neutral position in a non-operating state, a first force generating portion arranged in the operating portion to generate a first force, a moderating piece receiving the first force applied from the first force generating portion, a moderating portion having a moderating recessed part against which the moderating piece receiving the first force is pressed, a guide portion for guiding movement in a direction of the first force and in the opposite direction thereto when the operating portion is located in the neutral position, a second force generating portion for generating a second force to press the moderating portion against the moderating piece and a restricting portion capable of restricting movement of the moderating portion with respect to the guide portion.

### Embodiment

### Structure of Operating Device 1

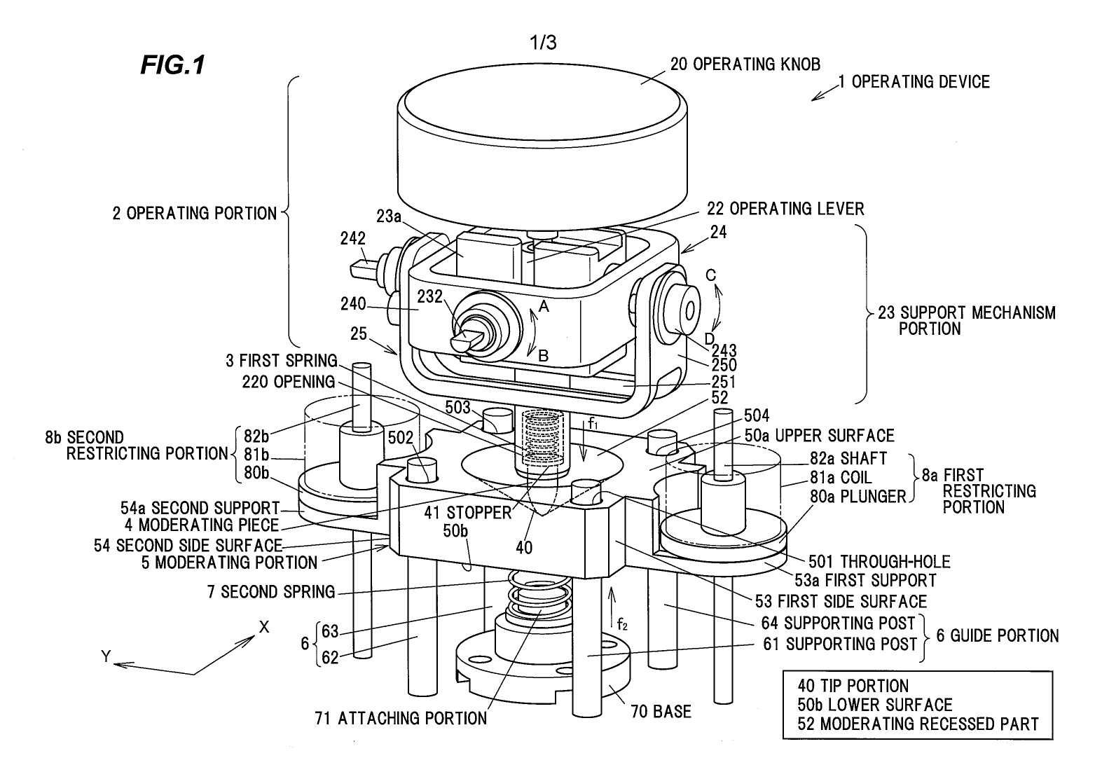

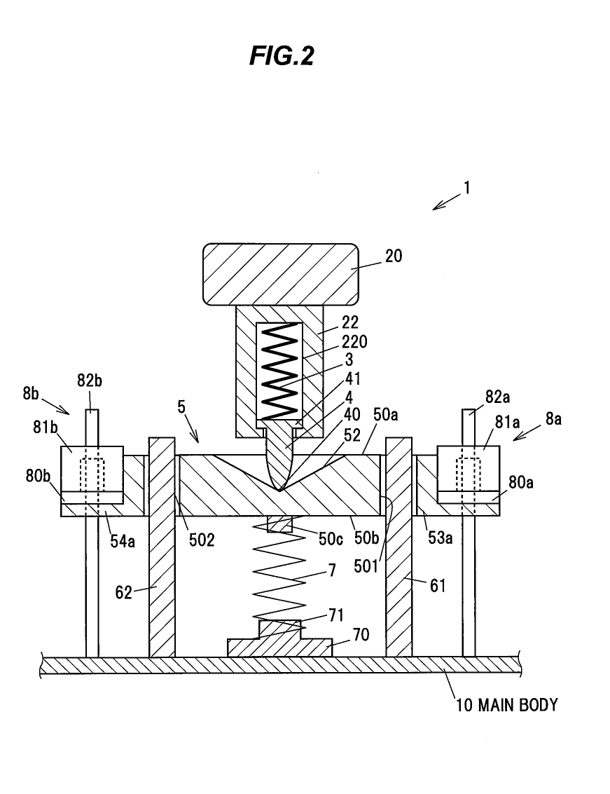

FIG. 1 is a schematic view showing an operating device in the embodiment. FIG. 2 is a diagram illustrating a schematic cross section of a major portion of the operating device in the embodiment. In FIG. 2, a simplified operating portion is shown. It should be noted that a proportion of part to part in each drawing of the embodiment may be different from an actual proportion.

An operating device 1 is, e.g., a remote control device for operating an electronic device mounted on a vehicle. As shown in FIG. 1, the operating device 1 is configured that an operating lever 22 can be operated to a desired operational position in X- and Y-axis directions, i.e., on the XY coordinate system. The XY coordinate system is an orthogonal coordinate system.

The operating device 1 is generally configured to mainly include an operating portion 2 which is in a neutral position in a non-operating state, a first spring 3 as the first force generating portion arranged in the operating portion 2 to generate a first force f₁, a moderating piece (detent piece) 4 receiving the first force f₁ applied from the first spring 3, a moderating portion (or detent portion) 5 having a moderating recessed part (or detent recessed part) 52 against which the moderating piece 4 receiving the first force f₁ is pressed, a guide portion 6 for guiding movement in a direction of the first force f₁ and in an opposite direction when the operating portion 2 is located in the neutral position, a second spring 7 as the second force generating portion for generating a second force f₂ to press the moderating portion 5 against the moderating piece 4, and a restricting portion capable of restricting movement of the moderating portion 5 with respect to the guide portion 6.

The restricting portion is composed of, e.g., a first restricting portion 8a and a second restricting portion 8b.

The operating device 1 is configured mainly to switch between a first operation load generated by the second force f₂ of the second spring 7 and a second operation load generated by the first force f₁ of the first spring 3. The first force f₁ is greater than the second force f₂. In the present embodiment, a ratio of the first load to the second load is set to, e.g., about 1:10.

### Structure of Operating Portion 2

As shown in FIG. 1, the operating portion 2 is generally configured to include an operating knob 20, the operating lever 22 and a support mechanism portion 23 for supporting the operating lever 22.

The operating lever 22 has, e.g., a columnar shape. The operating knob 20 is attached to one end portion of the operating lever 22 and an opening 220 is formed in another end portion. The operating knob 20 has, e.g., a columnar shape. An operator grips the operating knob 20 and operates the operating device 1 by a tilt operation of tilting the operating lever 22 in a desired direction.

The opening 220 is configured so that the inner side is wider than the entrance. Since a stopper 41 provided at an end potion of the below-described moderating piece 4 is larger than the entrance, the moderating piece 4 does not fall out of the opening 220. Therefore, a tip portion 40 of the moderating piece 4 protrudes from the opening 220.

### Structure of Support Mechanism Portion 23

The support mechanism portion 23 is generally configured to have a gimbal mechanism which supports the operating lever 22 so that a tilt operation by the operating lever 22 is allowed.

The support mechanism portion 23 is generally configured to include an operating lever supporting portion 23a, an X-axis supporting portion 24 and a Y-axis supporting portion 25. The operating lever 22 can be controlled to a desired operational position on the XY coordinate by a combination of the operating lever supporting portion 23a, the X-axis supporting portion 24 and the Y-axis supporting portion 25.

The operating lever supporting portion 23a supports the operating lever 22 so as to allow an operation in the Y-axis direction. In other words, the operating lever 22 is configured to rotate with respect to the operating lever supporting portion 23a. The rotating axis thereof is a support 232 protruding from a side surface of the X-axis supporting portion 24 and a non-illustrated support protruding from the side surface opposite to the support 232. It is possible to detect an operation amount in the Y-axis direction by providing, e.g., a rotation angle detection sensor on at least one of the support 232 and the non-illustrated support located on the opposite side. The support 232 rotates in arrow-A and -B directions, as shown in FIG. 1.

A main body 240 of the X-axis supporting portion 24 has a ring shape. The operating lever 22 supported by the operating lever supporting portion 23a is inserted into the ring. Then, the X-axis supporting portion 24 is supported by the Y-axis supporting portion 25.

The operating lever supporting portion 23a is rotatably supported by the X-axis supporting portion 24. The rotational direction thereof is the X-axis direction. The rotating axis thereof is supports 242 and 243 which protrude from a side surface of the Y-axis supporting portion 25. It is possible to detect an operation amount in the X-axis direction by providing, e.g., a rotation angle detection sensor on at least one of the supports 242 and 243. The supports 242 and 243 rotate in arrow-C and -D directions, as shown in FIG. 1.

The Y-axis supporting portion 25 is generally configured to include a main body 250 and a guide portion 251 for guiding a Y-axis operation of the operating lever 22 which is inserted therethrough.

Note that, the configuration of the support mechanism portion 23 is not limited to the above and the support mechanism portion 23 may be formed of a known support mechanism which can control a two-dimensional operational position.

### Structure of First Spring 3

The first spring 3 is arranged in the opening 220 at an end portion of the operating lever 22. The first spring 3 is, e.g., a coil spring formed by processing a metal material into a coil shape. Note that, the first force generating portion is not limited to the coil spring as long as it is a machine element which can generate the first force f₁ in a direction of pressing the moderating piece 4 against the moderating recessed part 52.

### Structure of Moderating Piece 4

The moderating piece 4 has a columnar shape and the tip portion 40 thereof has a rounded shape. The tip portion 40 is in contact with the moderating recessed part 52. Therefore, in accordance with the operation of the operating lever 22, the moderating recessed part 52 presses the tip portion 40 of the moderating piece 4 into the opening 220.

The moderating piece 4 has the stopper 41 as a retaining portion so as to be prevented from falling out of the opening 220 of the operating lever 22. In detail, the stopper 41 has a shape in which an outer periphery thereof is a slightly larger, as shown in FIG. 2.

### Structure of Moderating Portion 5

As shown in FIGS. 1 and 2, the moderating portion 5 has a plate shape which is square as viewed from the top. The moderating recessed part 52 is formed on an upper surface 50a of the moderating portion 5. The moderating recessed part 52 has a conical shape which is recessed from the upper surface 50a. In other words, the moderating recessed part 52 has a mortar-like shape.

The operating device 1 is in the neutral position when the moderating piece 4 is located at the bottom tip of the moderating recessed part 52. The neutral position is, e.g., the origin of the XY coordinate system.

In addition, the moderating portion 5 is provided with a first support 53a and a second support 54a which protrude from a first side surface 53 and a second side surface 54 opposite to the first side surface 53.

The first restricting portion 8a is arranged on the first support 53a. In addition, a non-illustrated through-hole through which a shaft 82a of the first restricting portion 8a is inserted is formed on the first support 53a.

The second restricting portion 8b is arranged on the second support 54a. In addition, a non-illustrated through-hole through which a shaft 82b of the second restricting portion 8b is inserted is formed on the second support 54a.

As shown in FIG. 2, the moderating portion 5 is provided with an attaching portion 50c on a lower surface 50b. The second spring 7 is attached to the attaching portion 50c.

In addition, through-holes 501 to 504 are formed on the moderating portion 5 at respective corners, as shown in FIG. 1. A supporting post 61 of the below-described guide portion 6 is inserted into the through-hole 501. A supporting post 62 of the below-described guide portion 6 is inserted into the through-hole 502. A supporting post 63 of the below-described guide portion 6 is inserted into the through-hole 503. A supporting post 64 of the below-described guide portion 6 is inserted into the through-hole 504.

### Structure of Guide Portion 6

The guide portion 6 is to guide movement of the moderating portion 5 in a vertical direction as viewed in the plane of the drawing. The guide portion 6 is generally configured to include the columnar-shaped supporting posts 61 to 64. The supporting posts 61 to 64 are attached to, e.g., a bottom surface 100 of a main body 10 of the operating device 1.

The moderating portion 5 does not move in the neutral position. The moderating portion 5 moves downward as viewed in the plane of FIGS. 1 and 2 based on the operation of the operating portion 2 while being guided by the guide portion 6 when the movement is not restricted by the first restricting portion 8a and the second restricting portion 8b. Meanwhile, the moderating portion 5 does not move when the movement is restricted by the first restricting portion 8a and the second restricting portion 8b.

### Structure of Second Spring 7

The second spring 7 is arranged between the moderating portion 5 and a base 70 which is arranged on the bottom surface 100 of the main body 10. One end of the second spring 7 is attached to the attaching portion 50c provided on the lower surface 50b of the moderating portion 5 and another end is attached to an attaching portion 71 protruding from the base 70.

The second spring 7 is, e.g., a coil spring formed by processing a metal material into a coil shape. Note that, the second force generating portion is not limited to the coil spring as long as it is a machine element which can generate the second force f₂ in a direction of pressing the moderating portion 5 against the moderating piece 4.

It should be noted that the spring constant of the first spring 3 is larger than that of the second spring 7 in the present embodiment.

### Structures of First Restricting Portion 8a and Second Restricting Portion 8b

The first restricting portion 8a is generally configured to include a plunger 80a arranged on the first support 53a, a coil 81a provided on the plunger 80a and the columnar-shaped shaft 82a which is inserted into the coil 81a. The plunger 80a is attached so as to be integrated with the first support 53a. Meanwhile, the coil 81a is attached so as to be integrated with the shaft 82a.

The plunger 80a is formed of, e.g., a metal material so as to have a shape composed of two stacked cylinders having different radii. The shaft 82a is inserted through the center of the plunger 80a. In addition, the cylinder having a smaller radius is inserted into the coil 81a. Accordingly, the plunger 80a is configured to move together with the moderating portion 5 while being guided by the shaft 82a.

Meanwhile, the second restricting portion 8b is generally configured to include a plunger 80b arranged on the second support 54a, a coil 81b provided on the plunger 80b and the columnar-shaped shaft 82b which is inserted into the coil 81b. The plunger 80b is attached so as to be integrated with the second support 54a. Meanwhile, the coil 81b is attached so as to be integrated with the shaft 82b.

The plunger 80b is formed of, e.g., a metal material so as to have a shape composed of two stacked cylinders having different radii. The shaft 82b is inserted through the center of the plunger 80b. In addition, the cylinder having a smaller radius is inserted into the coil 81b. Accordingly, the plunger 80b is configured to move together with the moderating portion 5 while being guided by the shaft 82b.

The shafts 82a and 82b are attached to, e.g., the bottom surface 100 of the main body 10.

The first restricting portion 8a and the second restricting portion 8b generate a force of attracting the plungers 80a and 80b when an electric current flows through the coils 81a and 81b. The first restricting portion 8a and the second restricting portion 8b are configured to restrict the movement of the moderating portion 5 by the attractive force. It should be note that, the number, etc., of the restricting portions is not limited as long as it is possible to restrict the movement of the moderating portion 5. In addition, the restricting portion is not limited to the above-mentioned so-called solenoid actuator and it is possible to use a well-known configuration as long as the moderating portion 5 is restricted from moving and is released from the restriction. As a modification of the restricting portion, the restricting portion may be, e.g., an actuator which can protrude and retract a convex portion into and from a recessed portion formed on a side surface of the moderating portion 5. This modification allows the movement of the moderating portion 5 to be restricted by protruding the convex portion of the restricting portion so as to fit into the recessed portion of the moderating portion.

Switching of an operation load of the operating device 1 in the embodiment will be described below in reference to each drawing.

### Switching of Operation Load

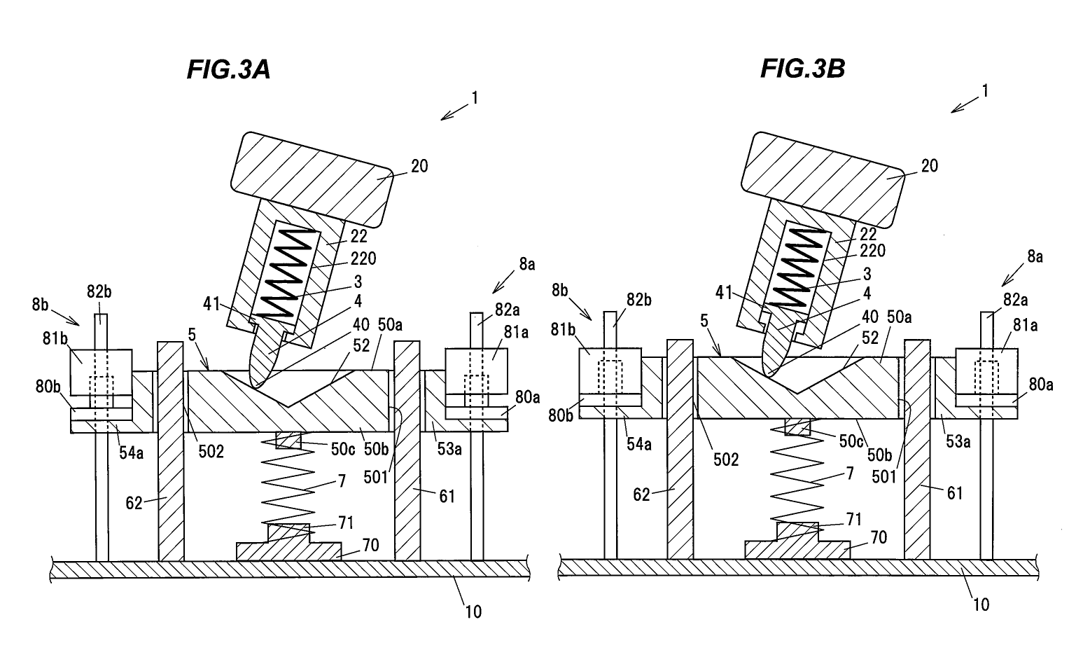

FIG. 3A is a diagram illustrating a schematic cross section of the major portion in the embodiment when movement of a moderating portion is not restricted and FIG. 3B is a diagram illustrating a schematic cross section of the major portion when the movement of the moderating portion is restricted. In FIGS. 3A and 3B, the simplified operating portion 2 is shown.

In the operating device 1, when the operating lever 22 is tilt-operated to the right side in the plane of FIG. 3A, the moderating portion 5 is pressed by the moderating piece 4 and moves while being guided by the guide portion 6 toward the lower side in the plane of FIG. 3A. Note that, in the operating device 1 of the present embodiment, there is a difference in spring constant between the first spring 3 and the second spring 7 to the extent that the first spring 3 is hardly compressed in a compression direction by this tilt operation. In other words, since the moderating piece 4 is restricted from falling out from the opening 220 by the stopper 41, it is possible to configure the first spring 3 to be harder than the second spring 7.

Since the first spring 3 is hardly compressed by this tilt operation, the moderating piece 4 moves on an inclined surface of the moderating recessed part 52 based on the operation of the operating lever 22. The second spring 7 is compressed in a compression direction as the moderating portion 5 further moves toward the lower side in the plane of FIG. 3A while being guided by the guide portion 6. Therefore, the first operation load felt by an operator is the operation load based on the second spring 7.

When the operator releases a hand from the operating knob 20 after the tilt operation, the operating portion 2 and the moderating portion 5 move, from an unstable state in which the tip portion 40 of the moderating piece 4 is in contact with the inclined surface of the moderating recessed part 52 to a stable state in which the tip portion 40 is in contact with the center of the moderating recessed part 52. This movement restores the operating portion 2 to the neutral position.

On the other hand, in the operating device 1, when an electric current flows through the coil 81a of the first restricting portion 8a and the coil 81b of the second restricting portion 8b, the plungers 80a and 80b are attracted thereto and the movement of the moderating portion 5 is restricted, as shown in FIG. 3B.

When the operating lever 22 is tilt-operated to the right side in the plane of FIG. 3B in a state that the plungers 80a and 80b are attracted and the movement of the moderating portion 5 is restricted, the moderating piece 4 is pressed toward the inside of the opening 220 by the inclined surface of the moderating recessed part 52 and only the first spring 3 is compressed in a compression direction.

Therefore, the second spring 7 is not compressed in a compression direction while only the first spring 3 is compressed, and accordingly, only an elastic force generated by the first spring 3 is applied to the moderating piece 4. This operation load is the second operation load. When the operator releases a hand from the operating knob 20 after this tilt operation, the operating portion 2 moves, from an unstable state in which the tip portion 40 of the moderating piece 4 is in contact with the inclined surface of the moderating recessed part 52 to a stable state in which the tip portion 40 is in contact with the center of the moderating recessed part 52. This movement restores the operating portion 2 to the neutral position.

That is, the first operation load when not restricting the moderating portion 5 from moving is smaller than the second operation load when restricting the moderating portion 5 from moving. In other words, the second operation load is larger than the first operation load. In this case, a magnitude relation between the spring constant of the first spring 3 and that of the second spring 7 is a magnitude relation of the operation load.

When, as a modification of the operating device 1, the moderating piece 4 does not have the stopper 41, i.e., when it is possible to change back to a model having the moderating portion 5 located between the first spring 3 and that of the second spring 7 in each of which one of end portions is a fixed end, the spring constant of the combination is the sum of the spring constant of the first spring 3 and that of the second spring 7. Therefore, the first operation load when not restricting of the moderating portion 5 from moving is larger than the second operation load when restricting the moderating portion 5 from moving. In any of the above cases, the operating device 1 can switch the operation load by providing or not providing an electric current to the coils 81a and 81b.

### Effects of the Embodiment

The operating device 1 of the present embodiment can switch the operation load by a simple structure. In detail, in the operating device 1, it is possible to easily generate two operation loads by restricting or not restricting the movement of the moderating portion 5 using the first restricting portion 8a and the second restricting portion 8b. Therefore, the operating device 1 can switch the operation load by a simple structure, which reduces the manufacturing cost as compared to the case of generating an operation load by a motor, etc.

In addition, the operating device 1 can switch the operation load more easily than the case of detecting the position of the operating portion to generate an operation load and controlling the operation load with a sophisticated process. Furthermore, since the operating device 1 does not require a control unit for the sophisticated process, the manufacturing cost is reduced.

In addition, the operating device 1 has the stopper 41 which prevents the moderating piece 4 from falling out of the opening 220. Therefore, the operating device 1 allows the spring constant of the first spring 3 to be larger than that of the second spring 7 to the extent that the first spring 3 is hardly compressed in a state that the movement of the moderating portion 5 is not restricted, and accordingly, it is possible to configure such that the magnitude relation of the spring constant is equivalent to the magnitude relation of the operation load, which facilitates setting of the operation load.

In the operating device 1, since the moderating recessed part 52 has a mortar-like shape, it is possible to restore the operating lever 22 to the neutral position without control when the operator does no longer support the operating portion 2.

Although the operation load is generated by the first spring 3 and the second spring 7 in the embodiment, it is not limited thereto and the operation load may be generated by arranging plural additional springs. In addition, the first and second force generating portions may be an elastic member formed of a resin, etc.

In addition, although the first spring 3 and the moderating piece 4 are arranged in the opening 220 of the operating lever 22 in the embodiment, it is not limited thereto and the first spring 3 may be arranged in an opening formed in the moderating piece 4 and be attached to an end portion of the operating lever 22. In this configuration, the retaining portion is formed at the end portion of the operating lever 22.

Although some embodiment and modification of the invention have been described, the embodiment and modification are merely an example and the invention according to claims is not to be limited thereto. These new embodiment and modification may be implemented in various other forms, and various omissions, substitutions and changes, etc., can be made without departing from the gist of the invention. In addition, all combinations of the features described in the embodiment and modification are not necessary to solve the problem of the invention. Further, these embodiment and modification are included within the scope and gist of the invention and also within the invention described in the claims and the range of equivalency.

What is claimed is:

1. An operating device, comprising:
an operating portion that is in a neutral position in a non-operating state;
a first force generating portion arranged in the operating portion to generate a first force;
a moderating piece to receive the first force applied from the first force generating portion;
a moderating portion comprising a moderating recessed part against which the moderating piece receiving the first force is pressed;
a guide portion to guide a movement in a direction of the first force and in the opposite direction thereto when the operating portion is located in the neutral position;
a second force generating portion to generate a second force to press the moderating portion against the moderating piece; and
a restricting portion to restrict a movement of the moderating portion relative to the guide portion.

2. The operating device according to claim 1, wherein the operating portion comprises an opening at an end, and the first force generating portion and the moderating piece are arranged in the opening.

3. The operating device according to claim 2, wherein the moderating piece comprises a retaining portion for preventing the moderating piece from falling out of the opening.

4. The operating device according to claim 1, wherein the first force is greater than the second force.

5. The operating device according to claim 1, wherein the restricting portion is composed of first and second restricting portions, and the moderating portion comprises a first support provided on a first side surface to support the first restricting portion and a second support provided on a second side surface opposite to the first side surface to support the second restricting portion.

6. The operating device according to claim 4, wherein the second force generating portion substantially provides the operating portion with a first operation load before the restricting portion restricts the movement of the moderating portion relative to the guide portion, and
wherein the first force generating portion provides the operating portion with a second operation load when the restricting portion restricts the movement of the moderating portion relative to the guide portion.

7. The operating device according to claim 6, wherein the second operation load is greater than the first operation load.

8. The operating device according to claim 6, wherein the first force generating portion and the second force generating portion each comprises a resilient member.

9. The operating device according to claim 6, wherein the restricting portion comprises an actuator comprising a solenoid and configured to restrict the movement of the moderating portion relative to the guide portion.

10. The operating device according to claim 6, wherein the restricting portion comprises an actuator comprising an engaging part and configured to restrict the movement of the moderating portion relative to the guide portion.
